(19) United States
(12) Patent Application Publication
(10) Pub. No.: US 2026/0009540 A1
(43) Pub. Date: Jan. 8, 2026

(54) FUEL NOZZLE

(71) Applicant: General Electric Company, Schenectady, NY (US)

(72) Inventors: Marco Venturato, Lebanon, OH (US); James Shealy, Cincinnati, OH (US); Bernard Gustav Knolle, Plaistow, NH (US); Michael T. Bucaro, Arvada, CO (US); Brian M. Royer, Liberty Township, OH (US)

(73) Assignee: General Electric Company, Schenectady, NY (US)

(21) Appl. No.: 18/671,371

(22) Filed: May 22, 2024

(51) Int. Cl. F23R 3/12; F02C 7/22

(52) U.S. Cl. CPC F23R 3/12; F02C 7/22

(57) ABSTRACT

A fuel nozzle for a turbine engine. The fuel nozzle has a premixer body, vortex generator, air injection orifice, and fuel injection orifice. The premixer body defines a primary flow path. The air injection orifice is provided in the premixer body and located downstream of the vortex generator. The fuel injection orifice is provided in the premixer body and opens into the primary flow path.

### TECHNICAL FIELD

The present subject matter relates generally to a fuel nozzle, and more specifically to a turbine engine having a combustion section including the fuel nozzle.

### BACKGROUND

Turbine engines are driven by a flow of combustion gases passing through the engine to rotate a multitude of turbine blades, which, in turn, rotate a compressor to provide compressed air to the combustor for combustion. A combustor can be provided within the turbine engine and is fluidly coupled with a turbine into which the combusted gases flow.

The use of hydrocarbon fuels in the combustor of a turbine engine is known. Generally, air and fuel are fed to a combustion chamber, the air and fuel are mixed, and then the fuel is burned in the presence of the air to produce hot gas. The hot gas is then fed to a turbine where it cools and expands to produce power. By-products of the fuel combustion typically include environmentally unwanted byproducts, such as nitrogen oxide and nitrogen dioxide (collectively called NOₓ), carbon monoxide (CO), unburned hydrocarbon (UHC) (e.g., methane and volatile organic compounds that contribute to the formation of atmospheric ozone), and other oxides, including oxides of sulfur (e.g., SO₂ and SO₃).

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic representation of a turbine engine, the turbine engine including a compression section, a combustion section, and a turbine section.

FIG. 2 depicts a cross-section view of the combustion section taken along line II-II of FIG. 1, further illustrating a set of fuel nozzles.

FIG. 3 is a schematic of a side cross-sectional view taken along line III-III of FIG. 2, further illustrating a fuel nozzle exhausting into a combustion chamber.

FIG. 4 is a schematic side cross-sectional view of a fuel nozzle suitable for use within the set of fuel nozzles of FIG. 2.

FIG. 5 is a schematic cross-section view of the fuel nozzle as seen from sectional line V-V of FIG. 4.

FIG. 6 is a schematic perspective view of a vortex generator of the set of vortex generators provided along the premixer body of the fuel nozzle of FIG. 4.

FIG. 7 is a schematic of a side cross-sectional view of the premixer body of the fuel nozzle and the vortex generator of FIG. 6.

### DETAILED DESCRIPTION

Aspects of the disclosure described herein are directed to a turbine engine including a combustion section. The combustion section includes a fuel nozzle. The fuel nozzle includes a premixer body. The premixer body defines a primary flow path. The fuel nozzle includes a set of fuel injection channels and a set of vortex generators. The set of vortex generators are provided along the premixer body and extend into the primary flow path. The set of fuel injection channels exhausts into the primary flow path at set of fuel injection orifices. Each fuel injection orifice of the set of fuel injection orifices is provided downstream of a leading edge of a respective vortex generator of the set of vortex generators. As used herein, a vortex generator is any suitable body that is configured to redirect a flow of fluid that flows over the vortex generator from an upstream end, or leading edge, and towards a downstream edge, or trailing edge, of the vortex generator. The redirection of the flow of fluid that flows over the vortex generator creates at least one vortex downstream of the vortex generator.

The fuel nozzle is especially well adapted for the use of hydrogen fuel (hereinafter, “H2 fuel”). Specifically, the fuel nozzle is especially well adapted to feed a flow of H2 fuel to the combustion chamber. The flow of H2 fuel can include a gaseous H2 fuel, a liquid H2 fuel, or a combination thereof. The flow of H2 fuel can further be mixed with other fuels or fluids such as, but not limited to, natural gas, coke oven gas, diesel, Jet-A, or the like. H2 fuels, when compared to traditional fuels (e.g., carbon fuels, petroleum fuels, etc.), have a higher burn temperature and velocity. H2 fuels, especially lean H2 fuel mixtures (e.g., mixtures of air and fuel with a relatively low volume of H2 fuel), have a higher chance of forming pockets of H2 fuel within the mixture that in turn increase the risk of flashback occurring. As used herein, “flashback” refers to an uncontrolled combustion or propagation of flame into an unwanted area of the combustion section (e.g., within the fuel nozzle). The use of the set of vortex generators ensure a homogenous mixture of H2 fuel and air that is moving at an adequate velocity to ensure that flashback does not occur. The homogenous mixture is further advantageous as the homogenous mixture reduces the amount of NOₓ emissions associated with the combustion of the H2 fuel.

The term “nozzle” has been used in various ways in the context of gas turbine engines. In the instant application, “nozzle” refers to a component having a portion for fluid coupling to a fuel supply and having at least one portion for fluidly coupling with a combustion chamber.

As used herein, the term “gaseous fuel” or iterations thereof refers to a combustible fuel in a gaseous state. It will be appreciated that gaseous fuel is different from atomized fuel. Atomized fuel utilizes an impeller, orifices, or the like to take a liquid fuel and atomize the liquid fuel into very small droplets.

For purposes of illustration, the present disclosure will be described with respect to a turbine engine (gas turbine engine). It will be understood, however, that aspects of the disclosure described herein are not so limited and that a fuel nozzle as described herein can be implemented in engines, including but not limited to turbojet, turboprop, turboshaft, and turbofan engines. Aspects of the disclosure discussed herein may have general applicability within non-aircraft engines having a combustor, such as other mobile applications and non-mobile industrial, commercial, and residential applications.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first” and “second” may be used interchangeably to distinguish one component from another and are not intended to signify location or importance of the individual components.

The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine nozzle or exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

The term “fluid” may be a gas or a liquid. The term “fluid communication” means that a fluid is capable of making the connection between the areas specified.

Additionally, as used herein, the terms “radial” or “radially” refer to a direction away from a common center. For example, in the overall context of a turbine engine, radial refers to a direction along a ray extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

“Hydraulic diameter” (Dh) as used herein is in reference to a hydraulic diameter of one or more cavities or openings (e.g., an outlet of a fuel nozzle) of a finished (e.g., manufactured) fuel nozzle. Hydraulic diameter is a commonly used term when handling flow in non-circular tubes and channels. When the cross-section is uniform along the tube or channel length, it is defined as

$${D}_{H} = \frac{4 a}{p}$$

where “a” is the cross-sectional area of the flow and “p” is the wetted perimeter of the cross-section. The hydraulic diameter can further be indirectly related to the Reynolds number of the fluid flow. As such, the hydraulic diameter can be used to at least partially quantify the flow of fluid through an area or pipe. It will be appreciated that the specific calculations for the hydraulic diameter are known and referenced herein without direct reference.

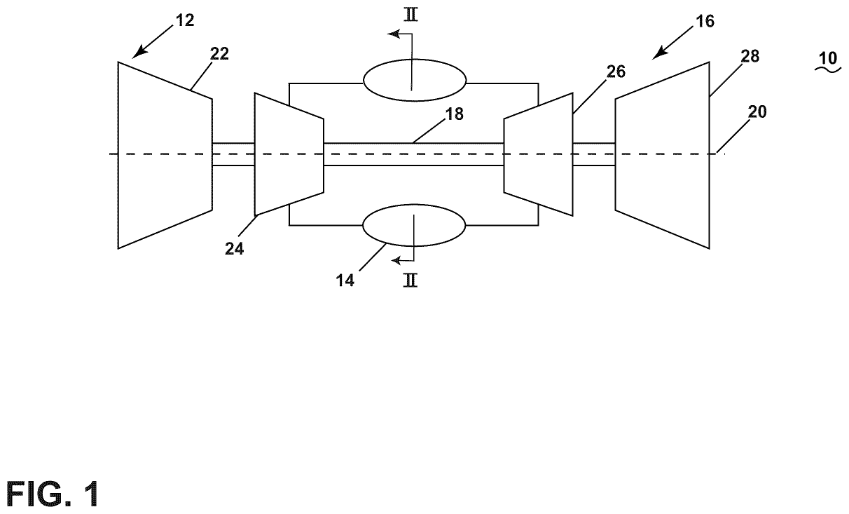

FIG. 1 is a schematic view of a turbine engine 10. As a non-limiting example, the turbine engine 10 can be used within an aircraft. The turbine engine 10 includes, at least, a compression section 12, a combustion section 14, and a turbine section 16 in serial flow arrangement. A drive shaft 18 rotationally couples the compression section 12 and the turbine section 16, such that rotation of one affects the rotation of the other, and defines a rotational axis or engine centerline 20 for the turbine engine 10.

The compression section 12 can include a low-pressure (LP) compressor 22, and a high-pressure (HP) compressor 24 serially fluidly coupled to one another. The turbine section 16 can include an LP turbine 26, and an HP turbine 28 serially fluidly coupled to one another. The drive shaft 18 operatively couples the LP compressor 22, the HP compressor 24, the LP turbine 26 and the HP turbine 28 together. Alternatively, the drive shaft 18 can include an LP drive shaft (not illustrated) and an HP drive shaft (not illustrated). The LP drive shaft couples the LP compressor 22 to the LP turbine 26, and the HP drive shaft couples the HP compressor 24 to the HP turbine 28. An LP spool is defined as the combination of the LP compressor 22, the LP turbine 26, and the LP drive shaft such that the rotation of the LP turbine 26 applies a driving force to the LP drive shaft, which in turn rotates the LP compressor 22. An HP spool is defined as the combination of the HP compressor 24, the HP turbine 28, and the HP drive shaft such that the rotation of the HP turbine 28 applies a driving force to the HP drive shaft which in turn rotates the HP compressor 24.

The compression section 12 includes a plurality of axially spaced stages. Each stage includes a set of circumferentially-spaced rotating blades and a set of circumferentially-spaced stationary vanes. The compressor blades for a stage of the compression section 12 can be mounted to a disk, which is mounted to the drive shaft 18. Each set of blades for a given stage can have its own disk. The vanes of the compression section 12 can be mounted to a casing which can extend circumferentially about the turbine engine 10. It will be appreciated that the representation of the compression section 12 is merely schematic and that there can be any number of stages. Further, it is contemplated that there can be any other number of components within the compression section 12.

Similar to the compression section 12, the turbine section 16 includes a plurality of axially spaced stages, with each stage having a set of circumferentially-spaced, rotating blades and a set of circumferentially-spaced, stationary vanes. The turbine blades for a stage of the turbine section 16 can be mounted to a disk which is mounted to the drive shaft 18. Each set of blades for a given stage can have its own disk. The vanes of the turbine section 16 can be mounted to the casing in a circumferential manner. It is noted that there can be any number of blades, vanes and turbine stages as the illustrated turbine section is merely a schematic representation. Further, it is contemplated that there can be any other number of components within the turbine section 16.

The combustion section 14 is provided serially between the compression section 12 and the turbine section 16. The combustion section 14 is fluidly coupled to at least a portion of the compression section 12 and the turbine section 16 such that the combustion section 14 at least partially fluidly couples the compression section 12 to the turbine section 16. As a non-limiting example, the combustion section 14 can be fluidly coupled to the HP compressor 24 at an upstream end of the combustion section 14 and to the HP turbine 28 at a downstream end of the combustion section 14.

During operation of the turbine engine 10, ambient or atmospheric air is drawn into the compression section 12 via a fan (not illustrated) upstream of the compression section 12, where the air is compressed defining a compressed air. The compressed air then flows into the combustion section 14 where the compressed air is mixed with fuel and ignited to generate combustion gases. Some work is extracted from these combustion gases by the HP turbine 28, which drives the HP compressor 24. The combustion gases are discharged into the LP turbine 26, which extracts additional work to drive the LP compressor 22, and the exhaust gas is ultimately discharged from the turbine engine 10 via an exhaust section (not illustrated) downstream of the turbine section 16. The driving of the LP turbine 26 drives the LP spool to rotate the fan (not illustrated) and the LP compressor 22. The compressed air flow and the combustion gases can together define a working air flow that flows through the fan, compression section 12, combustion section 14, and turbine section 16 of the turbine engine 10.

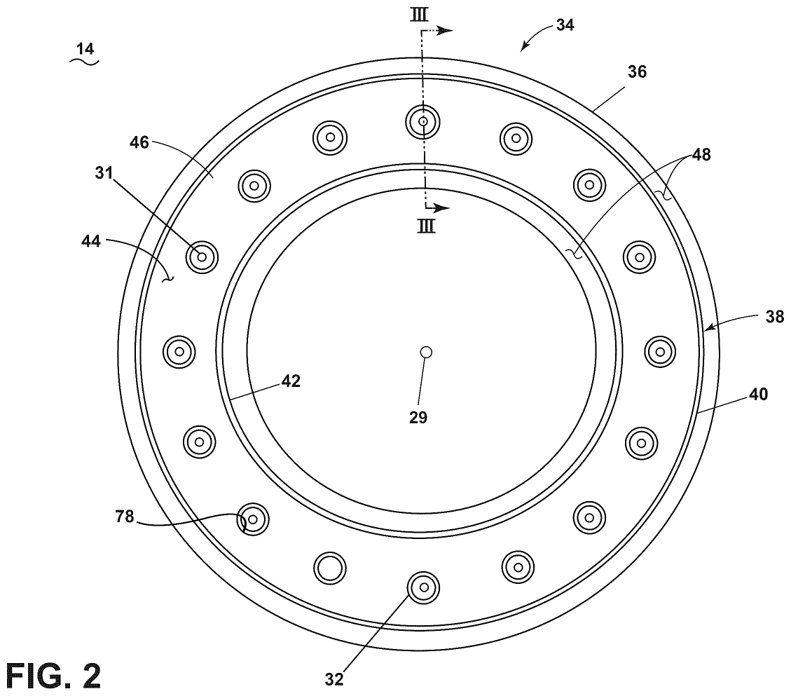

FIG. 2 depicts a cross-sectional view of the combustion section 14 along line II-II of FIG. 1. For purposes of illustration, the drive shaft 18 (FIG. 1) has been removed. The combustion section 14 includes a combustor 34. The combustor 34 includes a dome wall 44 including a set of fuel nozzle openings (not illustrated). The combustor 34 includes a set of fuel nozzles 32 extending through the set of fuel nozzle openings. The set of fuel nozzles 32 annularly arranged about a combustor centerline 30. The combustor centerline 30 can be the engine centerline 20 (FIG. 1) of the turbine engine 10 (FIG. 1). Additionally, or alternatively, the combustor centerline 29 can be a centerline for the combustion section 14, a single combustor, or a set of combustors that are arranged about the combustor centerline 29. Each fuel nozzle of the set of fuel nozzles 32 includes a fuel nozzle centerline 31.

The set of fuel nozzles 32 are arranged about the combustor centerline 30. The set of fuel nozzles 32 can include rich cups, lean cups, or a combination of both rich and lean cups annularly provided about the engine centerline. It should be appreciated that the annular arrangement of fuel injectors can be one or multiple fuel injectors and one or more of the fuel injectors can have different characteristics. A combustor 34 is defined, at least in part, by a combustor liner 38. The combustor 34 can have a can, can-annular, or annular arrangement depending on the type of engine in which the combustor 34 is located. In a non-limiting example, the combustor 34 can have a combination arrangement as further described herein located within a casing 36 of the engine. The combustor liner 38, as illustrated by way of example, can be annular. The combustor liner 38 can include an outer combustor liner 40 and an inner combustor liner 42 concentric with respect to each other and annular about the engine centerline. A dome wall 44 together with the combustor liner 38 can define a combustion chamber 46 having an annular configuration disposed about the engine centerline 20. The set of fuel nozzles 32 can be fluidly coupled to the combustion chamber 46. A compressed air passageway 48 can be defined at least in part by both the combustor liner 38 and the casing 36.

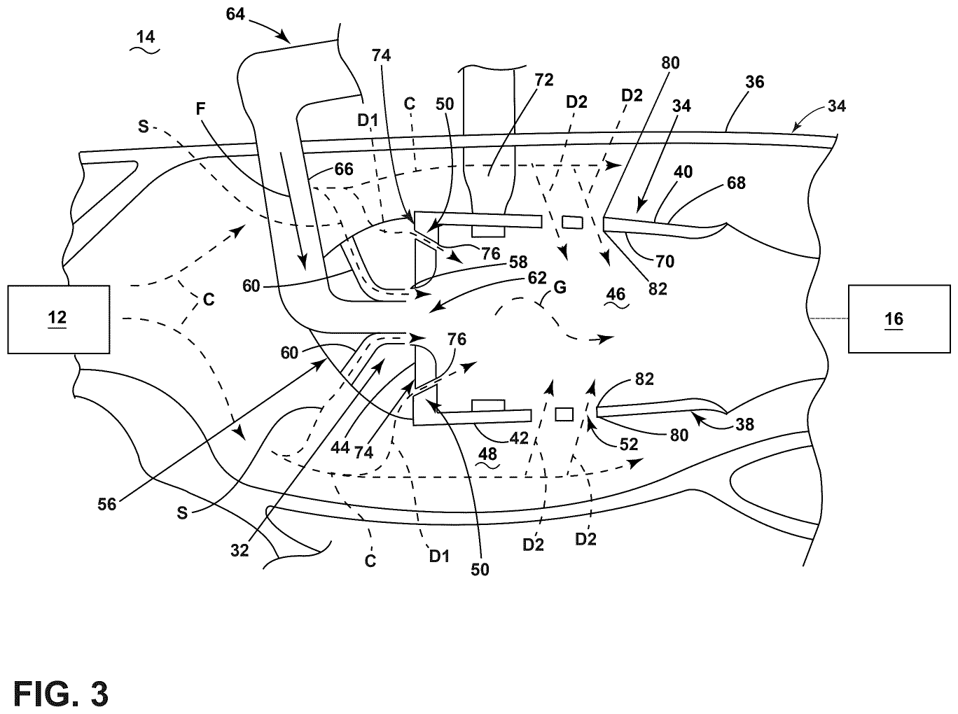

FIG. 3 depicts a cross-section view taken along line III-III of FIG. 2 illustrating the combustion section 14. At least one flame shaping passage can fluidly connect compressed air and the combustion chamber 46. By way of example, the at least one flame shaping passage is illustrated as first set of flame shaping holes 50 or second first set of flame shaping holes 52. The combustor 34 can include the first set of flame shaping holes 50, the second first set of flame shaping holes 52, or both the first set of flame shaping holes 50 and the second first set of flame shaping holes 52.

The first set of flame shaping holes 50 pass through the dome wall 44, fluidly coupling compressed air from the compression section 12 or the compressed air passageway 48 to the combustion chamber 46. The second first set of flame shaping holes 52 pass through the combustor liner 38, fluidly coupling compressed air from the compressed air passageway 48 to the combustion chamber 46.

Each fuel nozzle of the set of fuel nozzles 32 can be coupled to and disposed within a dome assembly 56. Each fuel nozzle of the set of fuel nozzles 32 can include a flare cone 58 and a swirler 60. The flare cone 58 includes an outlet 62 of the respective fuel nozzle outlet 62 directly fluidly coupled to the combustion chamber 46. Each fuel nozzle of the set of fuel nozzles 32 is fluidly coupled to a fuel inlet 64 via a passageway 66.

Both the inner combustor liner 42 and the outer combustor liner 40 have an outer surface 68 and an inner surface 70 at least partially defining the combustion chamber 46. The combustor liner 38 can be made of one continuous monolithic portion or be multiple monolithic portions assembled together to define the inner combustor liner 42 and the outer combustor liner 40. By way of non-limiting example, the outer surface 68 can define a first piece of the combustor liner 38 while the inner surface 70 can define a second piece of the combustor liner 38 that when assembled together form the combustor liner 38. As described herein, the combustor liner 38 includes the second first set of flame shaping holes 52. It is further contemplated that the combustor liner 38 can be any type of combustor liner 38, including but not limited to a single wall or a double walled liner or a tile liner. An ignitor 72 can be provided at the combustor liner 38 and fluidly coupled to the combustion chamber 46, at any location, by way of non-limiting example upstream of the second first set of flame shaping holes 52.

During operation, a compressed air (C) from a compressed air supply, such as the LP compressor 22 or the HP compressor 24 of FIG. 1, can flow from the compression section 12 to the combustor 34. A portion of the compressed air (C) can flow through the dome assembly 56. A first part of the compressed air (C) flowing through the dome assembly 56 can be fed to each fuel nozzle of the set of fuel nozzles 32 via the swirler 60 as a swirled airflow(S). A flow of fuel (F) is fed to each fuel nozzle of the set of fuel nozzles 32 via the fuel inlet 64 and the passageway 66. The swirled airflow(S) and the flow of fuel (F) are mixed at the flare cone 58 and fed to the combustion chamber 46 as a fuel/air mixture. The ignitor 72 can ignite the fuel/air mixture to define a flame within the combustion chamber 46, which generates a combustion gas (G). While shown as starting axially downstream of the outlet 62, it will be appreciated that the fuel/air mixture can be ignited at or near the outlet 62.

A second part of the compressed air (C) flowing through one or more portions of the dome assembly 56 can be fed to the first set of flame shaping holes 50 as a first flame shaping airflow (D1). That is, a portion of the compressed air (C) from the compression section 12 can flow through the dome wall 44 and into the combustion chamber 46 by passing through the first set of flame shaping holes 50. An inlet 74 is defined by a portion of one or more flame shaping holes of the first set of flame shaping holes 50. The inlet 74 is fluidly coupled to the compressed air (C). The first flame shaping airflow (D1) enters the one or more flame shaping holes of the first set of flame shaping holes 50 at the inlet 74 and exits the one or more flame shaping holes of the first set of flame shaping holes 50 at an outlet 76 located at the dome wall 44.

Another portion of the compressed air (C) can flow through the compressed air passageway 48 and can be fed to the second first set of flame shaping holes 52 as a second flame shaping airflow (D2). In other words, another portion of the compressed air (C) can flow axially past the dome assembly 56 and enter the combustion chamber 46 by passing through the second first set of flame shaping holes 52. That is, compressed air (C) can flow through the combustor liner 38 and into the combustion chamber 46 by passing through the second first set of flame shaping holes 52.

The first flame shaping airflow (D1) can be used to direct and shape the flame. The second flame shaping airflow (D2) can be used to direct the combustion gas (G). In other words, the first set of flame shaping holes 50 or the second first set of flame shaping holes 52 extending through the dome wall 44 or the combustor liner 38 direct air into the combustion chamber 46, where the directed air is used to control, shape, cool, or otherwise contribute to the combustion process in the combustion chamber 46.

The combustor 34 shown in FIG. 3 is well suited for the use of a hydrogen-containing gas as the fuel because it helps contain the faster moving flame front associated with hydrogen fuel, as compared to traditional hydrocarbon fuels. However, the combustor 34 can be used with traditional hydrocarbon fuels.

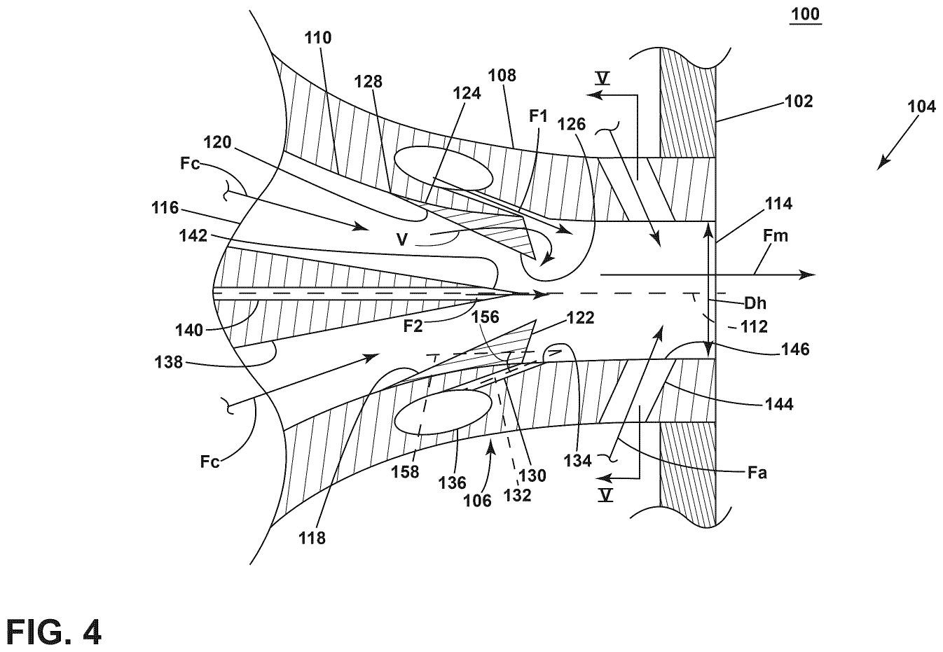

FIG. 4 is a schematic side cross-sectional view of a portion of a combustion section 100 suitable for use as the combustion section 14 of FIG. 1. The combustion section 100 is similar to the combustion section 14; therefore, like parts will be identified with like names, with it being understood that the description of the combustion section 14 applies to the combustion section 100 unless noted otherwise.

The combustion section 100 includes a wall 102 at least partially defining a combustion chamber 104. The wall 102 is any suitable wall at least partially defining the combustion chamber 104. As a non-limiting example, the wall 102 is at least one of a dome wall (e.g., the dome wall 44 of FIG. 3), the combustor liner (e.g., the combustor liner 38 of FIG. 3), or a combination thereof. The combustion section 100 includes a fuel nozzle 106. The fuel nozzle 106 can extend through the wall 102.

The fuel nozzle 106 includes a premixer body 108. The premixer body 108 defines a primary flow path 110. The premixer body 108 includes a premixer centerline 112. The primary flow path 110 exhausts into the combustion chamber 104 at a fuel nozzle outlet 114. The fuel nozzle 106 includes a set of fuel injection channels 130 and a set of air channels 144. The fuel nozzle 106 includes a set of vortex generators 118 provided along the premixer body 108 and extending into the primary flow path 110.

The primary flow path 110 extends between a compressed air inlet 116 and the fuel nozzle outlet 114. The compressed air inlet 116 can be formed as a series of channels, a continuous channel, a series of holes, or a combination thereof extending through the premixer body 108.

As a non-limiting example, the fuel nozzle outlet 114 can be a circle, a rectangle, an ellipse, a triangle, or any suitable shape when viewed along a plane perpendicular the premixer centerline 112 and intersecting the fuel nozzle outlet 114. The fuel nozzle outlet 114 is defined by a hydraulic diameter (Dh). The hydraulic diameter (Dh) can be greater than or equal to 0.1 inches and less than or equal to 5 inches.

The set of air channels 144 are at least partially formed within the premixer body 108. The set of air channels 144 include a set of air injection orifices 146 opening to the primary flow path 110. The set of air channels 144 can include any number of one or more channels, holes, slots, or a combination thereof circumferentially spaced along the premixer body 108. While described in terms of having set of air channels 144, it will be appreciated that the fuel nozzle 106 can be formed without set of air channels 144.

The set of fuel injection channels 130 are at least partially formed within the premixer body 108. The set of fuel injection channels 130 open to the primary flow path 110 at a set of fuel injection orifices 134. The set of fuel injection orifices 134 can include any number of one or more channels, holes, slots, or a combination thereof circumferentially spaced along the premixer body 108, with respect to the premixer centerline 112. Each fuel channel of the set of fuel injection channels 130 includes a respective fuel channel centerline 132. The set of fuel injection orifices 134 can be provided axially upstream of, axially downstream of, axially aligned with, or a combination thereof, with the set of air injection orifices 146.

Each fuel channel of the set of fuel injection channels 130 extends at a fuel channel angle 156 defined by an included angled between a projection 158 of the respective fuel channel centerline 132 and the premixer centerline 112. The fuel channel angle 156 can have an absolute value of greater than or equal to 0 degrees and less than or equal to 135 degrees. The fuel channel angle 156 can be the equal or non-equal between fuel channels of the set of fuel injection channels 130.

A fuel manifold 136 can be provided within the premixer body 108. The set of fuel injection channels 130 extend between the fuel manifold 136 and the set of fuel injection orifices 134.

The fuel nozzle 106 can include a centerbody 138 extending through the primary flow path 110. The centerbody 138 can include a central fuel channel 140 exhausting into the primary flow path 110 at a fuel jet 142. The centerbody 138 can include any number of one or more fuel jets 142 provided along any suitable portion of the centerbody 138. As a non-limiting example, the centerbody 138 can include a plurality of fuel jets at least one of circumferentially spaced along the centerbody 138, axially spaced along the centerbody 138, or a combination thereof with respect to the premixer centerline 112. The fuel jet 142 is axially aligned with, axially offset from, or a combination thereof from the set of fuel injection orifices 134.

The centerbody 138 can be integrally formed with or coupled to (e.g., through welding, adhesion, bonding, fastening, or the like) to the premixer body 108. The fuel nozzle 106 can include any number of one or more centerbodies 138 with any number of one or more central fuel channels 140. While described in terms of having the centerbody 138, it will be appreciated that the fuel nozzle 106 can be formed without the centerbody 138. As a non-limiting example, the set of fuel injection channels 130 can be the only source of fuel injection within the fuel nozzle 106.

Each vortex generator of the set of vortex generators 118 includes a leading edge 120, a trailing edge 122, a root 124, an apex 126 and a foot 128. The root 124 extends along the premixer body 108. The foot 128 is defined as where the root 124 meets the leading edge 120, or otherwise as a where the leading edge 120 meets the premixer body 108. The foot 128 is defined as the farthest upstream point or portion of the vortex generator. As a non-limiting example, the foot 128 can be defined as a portion of the vortex generator that is provided radially farthest from the premixer centerline 112. The apex 126 is defined as where the trialing edge 122 meets the leading edge 120, or otherwise as a radially farthest portion of the trailing edge 122 from the premixer body 108. As a non-limiting example, the apex 126 can be defined as a portion of the vortex generator radially closest to the premixer centerline 112.

Each vortex generator of the set of vortex generators 118 is integrally formed with or coupled (e.g., through welding, adhesion, bonding, fastening, or the like) to the premixer body 108. As a non-limiting example, each vortex generator of the set of vortex generators 118 can be integrally formed with the premixer body 108 and the root 124 can be defined as a transition from the premixer body 108 and to the vortex generator 118 rather than a wall or a surface of the vortex generator.

The set of vortex generators 118 includes any number of one or more vortex generators circumferentially spaced along the premixer body 108 with respect to the premixer centerline 112.

Each vortex generator of the set of vortex generators 118 includes a respective cross-sectional area when viewed along a plane extending along the premixer centerline 112 and intersecting the apex 126. The cross-sectional area of each vortex generator of the set of vortex generators 118 can include any suitable shape such as, but not limited to, a triangle, a semi-circle, a semi-ellipse, a rectangle, a trapezoid, or the like. The set of vortex generators 118 can be any suitable vortex generator configured to produce a respective vortex. As a non-limiting example, the set of vortex generators 118 can be at least one of a delta wing vortex generator, counter-rotating vortex generator, a double-sided wedge, wheeler, wing, winglet, Kuethe, wishbone, hairpin, lobed, wave-type, or any combination thereof.

The set of vortex generators 118 can each be uniformly formed or non-uniformly formed. In other words, two or more vortex generators of the set of vortex generators 118 can be identical or non-identical with respect to each other. As a non-limiting example, an apex 126 of a first vortex generator of the set of vortex generators 118 can be provided radially closer to the premixer centerline 112 than an apex 126 of a second vortex generator of the set of vortex generators 118. As a non-limiting example, a first vortex generator of the set of vortex generators 118 can be formed as a double-sided wedge, while a second vortex generator of the set of vortex generators 118 can be formed as a winglet.

Each fuel injection orifice of the set of fuel injection orifices 134 are provided at or along a nearest vortex generator of the set of vortex generators 118, or axially between a nearest air injection orifice of the set of air injection orifices 146 and the nearest vortex generator of the set of vortex generators 118. As used herein, a nearest vortex generator is a closest vortex generator of the set of vortex generators 118 to the fuel injection orifice 134 along a straight-line distance. As used herein, a nearest air injection orifice is a closest air injection orifice of the set of air injection orifices 146 to the fuel injection orifice 134 along a straight-line distance.

The premixer body 108 includes any suitable cross-sectional area when viewed along a plane extending along the premixer centerline 112. As a non-limiting example, the premixer body 108 can converge radially inward from an upstream portion to a downstream portion of the premixer body 108. As such, the primary flow path 110 can converge radially inwardly from an upstream portion and to a downstream portion. The fuel nozzle 106 can include any suitable construction. As a non-limiting example, the fuel nozzle 106 can be symmetric or asymmetric about the premixer centerline 112.

During operation, at least one flow of air, specifically compressed air, is fed to the fuel nozzle 106 from a compressed air supply. The compressed air supply can be, but is not limited to, the LP compressor 22, the HP compressor 24, or a combination thereof of FIG. 1.

The at least one flow of air can include a primary flow of compressed air (Fc) that is fed to the fuel nozzle 106 through the compressed air inlet 116. At least a portion of the primary flow of compressed air (Fc) flows over the set of vortex generators 118 to define a set of vortices (V) within the primary flow path 110. The set of vortices (V) are defined as a portion of the primary flow of compressed air (Fc) forming a vortex or vortices within the fuel nozzle 106. For purposes of illustration, only a single vortex of the set of vortices (V) is illustrated, however, it will be appreciated that any vortex generator of the set of vortex generators 118 that has a flow of fluid flow over the respective vortex generator will generate a respective vortex. Each vortex of the set of vortices (V) is formed directly downstream of a respective vortex generator of the set of vortex generators 118.

The at least one flow of air can include a secondary flow of air (Fa) can be fed to the primary flow path 110 through the set of air channels 144. The secondary flow of air (Fa) is emitted into the primary flow path 110 at a cross angle relative to the primary flow path 110. In other words, the secondary flow of air (Fa) is emitted into the primary flow path 110 at an angle that is non-parallel to the premixer centerline 112. The crossflow or non-parallel angling of the second flow of air (Fa) mixes the second flow of air (Fa) with other flows of fuel (e.g., a flow of fuel) within the primary flow path 110. The primary flow of compressed air (Fc), the secondary flow of air (Fa), or a combination thereof is fed from a compressed air supply, such as the LP compressor 22 or the HP compressor 24 of FIG. 1.

A primary flow of fuel (F1) is fed to the primary flow path 110 through the set of fuel injection channels 130. For purposes of illustration, the primary flow of fuel (F1) is shown only as being provided within one of the fuel channels of the set of fuel injection channels 130. However, it will be appreciated that any number of one or more fuel channels of the set of fuel injection channels can include a respective primary flow of fuel (F1). A secondary flow of fuel (F2) can be fed through the central fuel channel 140 and to the primary flow path 110.

The secondary flow of fuel (F2) and the primary flow of fuel (F1) can each include a respective H2 fuel, or mixture of fuel and another fluid. As a non-limiting example, the secondary flow of fuel (F2), the primary flow of fuel (F1), or a combination thereof can include an H2 fuel mixed with at least one steam, water, another fuel (e.g., Jet-A, diesel, natural gas, coke oven gas, etc.), or a combination thereof. It is contemplated that the fuel within the secondary flow of fuel (F2) can be the same or different fuel as the fuel within the primary flow of fuel (F1). As a non-limiting example, the primary flow of fuel (F1) can include the H2 fuel, while the secondary flow of fuel (F2) can include a flow of liquid H2 fuel. As a non-limiting example, at least one of the primary flow of fuel (F1), the secondary flow of fuel (F2) or a combination thereof can include (e.g., be a combination with or be made entirely of), but are not limited to, H2 fuel, natural gas, diesel, Jet-A, water, air, or the like. It is contemplated that at least one of the primary flow of fuel (F1), the secondary flow of fuel (F2), or a combination thereof can include a flow of 100% H2 fuel, or a mixture of H2 fuel and compressed air or another fuel (e.g., methane).

At least one of the primary flow of fuel (F1), the secondary flow of fuel (F2), or a combination thereof, mixes with at least one of the primary flow of compressed air (Fc) within the set of vortices (V), the secondary flow of air (Fa), or a combination thereof to define mixture of fuel and air (Fm). The mixture of fuel and air (Fm) is fed to the combustion chamber 104. The mixture of fuel and air (Fm) can be subsequently ignited to define a flame provided within the combustion chamber 104.

The set of vortices (V) are used to mix the primary flow of compressed air (Fc) with at least the primary flow of fuel (F1). As a non-limiting example, the primary flow of fuel (F1) is fed directly into the set of vortices (V), such that the primary flow of fuel (F1) follows a path of the set of vortices (V) within the primary flow path 110. The injection of the primary flow of fuel (F1) into the set of vortices (V) creates a homogenous mixture of fuel and compressed air. Put another way, the set of vortices (V) are used to evenly distribute at least the primary flow of fuel (F1) such that mixture of fuel and air (Fm) is defined by a homogenous mixture.

It will be appreciated that at least a portion of the vortex generators of the set of vortex generators 118 can be circumferentially oriented within the primary flow path 110. Put another way, at least a portion of the vortex generators of the set of vortex generators 118 can be oriented such that the primary flow of compressed air (Fc) is directed into a circumferential direction, with respect to the premixer centerline 112, when the primary flow of compressed air (Fc) flows over the set of vortex generators 118. This direction of the primary flow of compressed air (Fc), in turn, causes the primary flow of compressed air (Fc) to be swirled. The amount of swirl to the flow of fluid that flows over or through the set of vortex generators 118 is quantified by a swirl number defined as an integral of the tangential momentum to the axial momentum of the flow of fluid downstream of a respective vortex generator. The set of vortex generators 118 create a swirled air flow having swirl number of greater than 0 and less than or equal to 1.0. Put another way, the set of vortex generators 118 can be used in conjunction with or in place of a conventional swirler (e.g., the swirler 60 of FIG. 3).

The use of the set of vortex generators 118, along with the location of the set of fuel injection orifices 134, is especially important when utilizing H2 fuel. Specifically, the use of the set of vortex generators 118 ensure that the H2 fuel from, for example, the primary flow of fuel (F1), is fully mixed with the primary flow of compressed air (Fc). This, in turn, ensures the homogenous mixture of the mixture of fuel and air (Fm). The homogenous mixture is especially important when utilizing H2 fuel as an uneven distribution of H2 fuel will produce larger NOₓ emissions when ignited when compared to the homogenous mixture. As such, the fuel nozzle 106 is especially adapted for use with H2 fuels as the fuel nozzle 106 ensures that the mixture of fuel and air (Fm) is a homogenous mixture. Further the set of vortex generators 118 are used to limit the possibility of flashback from occurring, which will be discussed further at a later point.

While not illustrated, the combustion section 100 can include a controller module communicatively coupled to a set of valves in order to automatically control a flow of fluids to or within respective portions of the combustion section 100. As a non-limiting example, the controller module can automatically control a supply of the primary flow of compressed air (Fc), the primary flow of fuel (F1), the secondary flow of fuel (F2), the secondary flow of air (Fa), or a combination thereof, to the fuel nozzle 106. The flow of fluids to or within respective portions of the combustion section 100 can be done independently of one another. As a non-limiting example, the supply of the primary flow of fuel (F1) to the set of fuel injection orifices 134 can be independently of the supply of the secondary flow of fuel (F2) to the fuel jet 142.

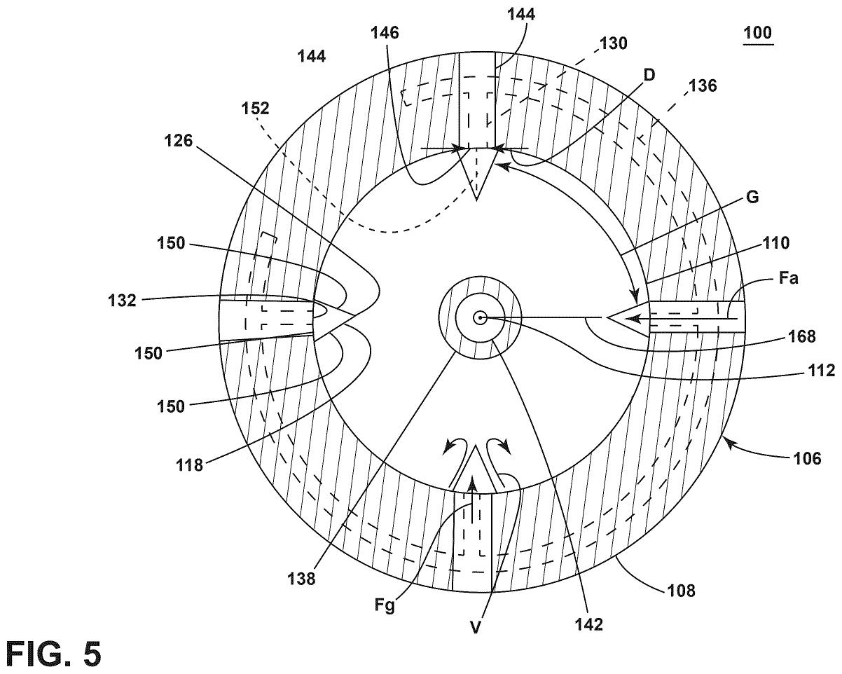

FIG. 5 is a schematic cross-section view of the fuel nozzle 106 as seen from sectional line V-V of FIG. 4. The fuel manifold 136 extends circumferentially within the premixer body 108, with respect to the premixer centerline 112. The fuel manifold 136 extends continuously or non-continuously about an entirety of or less than entirety of a circumferential extent of the premixer centerline 112.

Each vortex generator of the set of vortex generators 118 includes opposing side walls 150. The opposing side walls 150 are provided on circumferentially opposite sides of the vortex generator, with respect to the premixer centerline 112. Each vortex generator of the set of vortex generators 118 includes a vortex centerline 152 extending between the apex 126 and a point along the root 124 halfway between the opposing side walls 150. The vortex centerline 152 can be linear or non-linear. The vortex centerline 152 can be parallel to or non-parallel to a radial line 168 extending from the premixer centerline 112 and intersecting a respective portion of the vortex centerline 152. Each vortex generator of the set of vortex generators 118 can include a cross-sectional area when viewed along a plane perpendicular to the premixer centerline 112 and intersecting the apex 126. The cross-sectional area can include any suitable shape.

The set of vortex generators 118 are circumferentially spaced within the primary flow path 110 along with premixer body 108, with respect to the premixer centerline 112. A gap (G) is measured between opposing side walls 150 of circumferentially adjacent vortex generators 118.

At least one air channel of the set of air channels 144 is circumferentially aligned with a respective vortex generator the set of vortex generators 118. As a non-limiting example, each vortex generator of the set of vortex generators 118 can be circumferentially aligned with at least one air channel of the set of air channels 144. Alternatively, at least one air channel of the set of air channels 144 can be circumferentially offset from the set of vortex generators 118 such that the at least one air channel is provided within a respective gap (G).

The set of air channels 144 output the secondary flow of air (Fa) into the primary flow path 110 in any suitable direction. As a non-limiting example, at least a portion of the secondary flow of air (Fa) can be defined as a radial secondary flow of air (Fa) that is parallel to the radial line 168 extending from the premixer centerline 112 and intersecting the respective air channel of the set of air channels 144 that the secondary flow of air (Fa) is output from. As a non-limiting example, at least a portion of the secondary flow of air (Fa) can be defined as a circumferential secondary flow of air (Fa) that is non-parallel to the radial line 168 extending from the premixer centerline 112 and intersecting the respective air channel of the set of air channels 144 that the secondary flow of air (Fa) is output from. It will be appreciated that the all air channels of the set of air channels 144 can be formed the same or different with respect to one another. As a non-limiting example, one air channel of the set of air channels 144 can output the radial secondary flow of air (Fa), while a second air channel of the set of air channels 144 can output the circumferential second flow of air (Fa). It is contemplated that the circumferential secondary flow of air (Fa) can be used to produce a swirling effect of air within the primary flow path 110.

The set of fuel injection channels 130 are circumferentially spaced within the premixer body 108, with respect to the premixer centerline 112. A total number of fuel injection channels of the set of fuel injection channels 130 can be equal to a total number of vortex generators of the set of vortex generators 118. Each vortex generators of the set of vortex generators 118 can be circumferentially aligned with at least one fuel channel of the set of fuel injection channels 130. The set of air channels 144 are circumferentially spaced from both the set of vortex generators 118 and the set of fuel injection channels 130.

During operation, each vortex generator of the set of vortex generators 118 generates at least one vortex of the set of vortices (V). The number of vortices that that each vortex generator of the set of vortex generators 118 is dependent on the construction of the vortex generator. As a non-limiting example, the vortex generator being formed as a delta wing vortex generator will produce two vortices on opposing sides of the vortex generator. As a non-limiting example, the vortex generator being formed as a half-delta wing vortex generator will produce a single vortex. A vortex generator that produces a single vortex is referred to as a singlet vortex generator, while a vortex generator that produces two vortices is referred to as a doublet vortex generator. The set of vortex generators include at least one of the single vortex generator, the doublet vortex generator, or a combination thereof.

As illustrated, the set of vortex generators are doublet vortex generators. Put another way, each vortex generator of the set of vortex generators 118 includes opposing vortices of the set of vortices (V) on either side of the respective vortex generator. The set of fuel injection channels 130 are oriented such that the primary flow of fuel (F1) is exhausted directly into the pair of vortices. The set of air channels 144 exhaust the secondary flow of air (Fa) downstream of, but circumferentially aligned with, the set of vortex generators 118.

With reference to both FIGS. 4 and 5, it will be appreciated that the set of vortices (V) are produced downstream of the trailing edge 122. Specifically, as the flow of compressed air (Fc) flows over a respective vortex generator of the set of vortex generators 118, a low pressure zone is created downstream of the respective vortex generator. This low pressure zone causes the flow of compressed air (Fc) to turn, thus generating the set of vortices (V).

During operation, the set of vortices (V) slow down the primary flow of compressed air (Fc). In other words, the primary flow of compressed air (Fc) is slower where the set of vortices (V) are present in comparison to regions where the set of vortices (V) are not present (e.g., within the gaps (G)). The areas without the set of vortices (V) can be defined as negative areas as there are no vortex generators of the set of vortex generators 118 provided there. These negative areas are defined as portions of the primary flow path 110 with an increased velocity. In other words, there is a disparity in a velocity of the flow of fluid within the negative areas in comparison with the flow of fluid circumferentially aligned with and axially downstream of the set of vortex generators 118.

It is contemplated that allowing the disparity between the velocities due to the negative areas negatively impacts the function of the fuel nozzle 106. For example, if left unchecked, the disparity between the velocities creates shear layers of fluid within the mixture of fuel and air (Fm). These shear layers of fluid can break up the homogenous mixture of fuel and air in the mixture of fuel and air (Fm). Further, the disparity between the velocities can cause some of the fuel within the mixture of fuel and air (Fm) to stay back or recirculate axially away from the fuel nozzle outlet (FIG. 4). The recirculation of the fuel can, in turn, cause flashback within the fuel nozzle 106 once the mixture of fuel and air (Fm) is ignited within the combustion chamber 104. In other wors, the disparity between the velocities can cause ignition of fuel within the fuel nozzle 106. The risk of flashback is higher in cases where the fuel nozzle 106 is utilizing a fuel with a higher flame speed such as H2 fuels.

The fuel nozzle 106, as described herein, includes structure to address the disparity between the velocities. As a non-limiting example, at least a portion of the set of air channels 144 can be axially downstream of and circumferentially aligned with the set of vortex generators 118. At least a portion of the secondary flow of air (Fa) is used to speed up portions of the mixture of fuel and air (Fm) that is directly downstream of the set of vortex generators 118 such that there is no disparity between or a minimal disparity between the velocities. As a non-limiting example, a total number of vortex generators of the set of vortex generators 118 can be increased to minimize the size of the gaps (G). This, in turn, reduces the total size of the negative area, thus reducing the disparity between the velocities as less of the mixture of fuel and air (Fm) is moving faster than the mixture of fuel and air (Fm) directly downstream of the set of vortex generators 118.

At least a portion of the secondary flow of air (Fa) can further be used to shape the flow of fluid within the fuel nozzle 106. As a non-limiting example, the secondary flow of air (Fa) can provide a swirling effect to the flow of fluid, or otherwise be used to condense (e.g., condense radially closer to the premixer centerline 112) the flow of fluid within the fuel nozzle. 106. The shaping of the flow of fluid within the fuel nozzle 106 can be used to push the flow of fluid within the fuel nozzle 106 radially away from the premixer body 108. Pushing the flow of fluid radially away from the premixer body 108, in turn, discourages the fuel from entering the contacting the premixer body 108, or otherwise getting stuck in regions radially near the premixer body 108. Reducing or eliminating the amount of fuel that can be present in these regions between the flow of fluid and the premixer body 108, in turn, minimizes the risk of flashback by reducing the amount of fuel outside of the mixed flow of fuel and air (Fm).

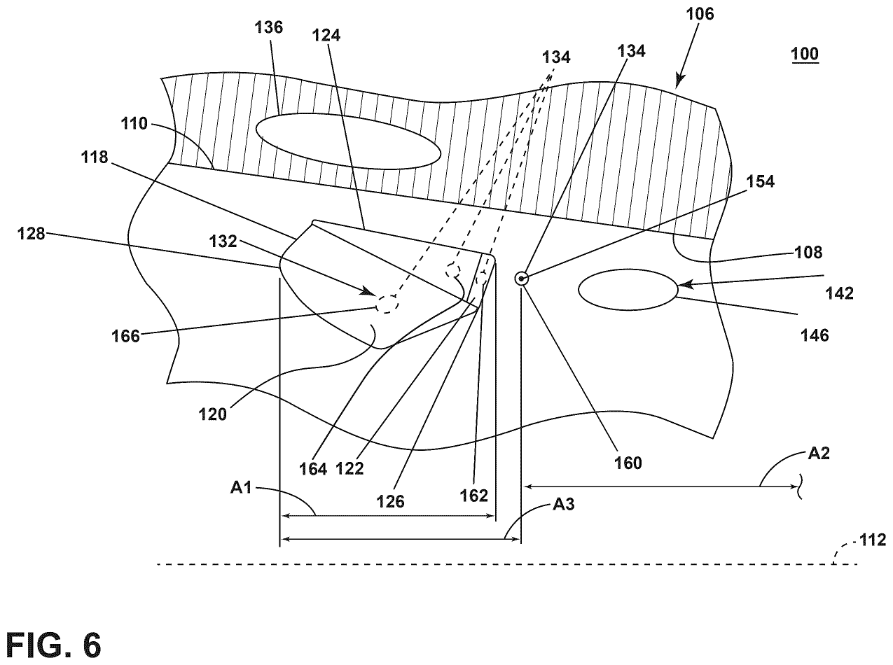

FIG. 6 is a schematic perspective view of a vortex generator 118 of the set of vortex generators 118 provided along the premixer body 108 of the fuel nozzle 106 of FIG. 4.

A set of fuel injection orifices 134, illustrated in phantom lines, can be circumferentially aligned with the vortex generator 118. The set of fuel injection orifices 134 can be provided along any suitable portion of the vortex generator 118, the premixer body 108, or a combination thereof. As a non-limiting example, the fuel injection orifice 134 can be provided at least one of a first fuel orifice location 160, a second fuel orifice location 162, a third fuel orifice location 164, a fourth fuel orifice location 166, or a combination thereof. The first fuel orifice location 160 is provided downstream of the foot 128 along the premixer body 108 (e.g., not along the vortex generator 118). The second fuel orifice location 162 is provided along the leading edge 122 of the vortex generator 118. The third fuel orifice location 164 is provided between the leading edge 120 and the trailing edge 122 (e.g., along at least one of the opposing side walls 150). The fourth fuel orifice location 166 is provided along the leading edge 122. Each of the first fuel orifice location 160, the second fuel orifice location 162, the third fuel orifice location 164, and the fourth fuel orifice location 166 are provided downstream of the foot 128. Alternatively, at least one fuel orifice of the set of fuel injection orifices 134 can be provided upstream of the foot 128. The set of fuel injection orifices 134, in all cases, are provided axially forward of a respective air channel of the set of air channels 144 that the set of fuel injection orifices 134 are circumferentially nearest.

Each vortex generator of the set of vortex generators 118 extends axially, with respect to the premixer centerline 112, a first axial distance (A1). A center point 154, defined as the fuel channel centerline 132 (FIG. 3) at a respective fuel injection orifice of the set of fuel injection orifices 134, is provided a second axial distance (A2) from the fuel nozzle outlet 114, with respect to the premixer centerline 112. The center point 154 is a third axial distance (A3) from an axially forwardmost portion of the nearest vortex generator 118, with respect to the premixer centerline 112. The first axial distance (A1) can be greater than or equal to the second axial distance (A2). The first axial distance (A1) can be greater than, equal to, or less than the third axial distance (A3). As a non-limiting example, the first axial distance (A1) can be greater than 0% and less than or equal to 500% of the third axial distance (A3).

With reference to FIGS. 4 and 6, the hydraulic diameter (Dh) of the fuel nozzle outlet 114 is defined with respect to the second axial distance (A2). As a non-limiting example, the second axial distance (A2) can be greater than 0 times and less than or equal to 200 times the hydraulic diameter (Dh).

The fuel nozzle 106 is defined by a bluff area and a flow area. The bluff area is defined as a total surface area of the physical structure of the fuel nozzle 106 and the wall 102 confronting the combustion chamber 104 (FIG. 4). The flow area is defined as a volume of the primary flow path 110 between the fuel nozzle outlet 114 and the compressed air inlet 116 for a single fuel nozzle 106. A ratio between the bluff area and the flow area is greater than or equal to 0.01 and less than or equal to 10.

The fuel nozzle 106 is defined by a fuel injection orifice area. fuel injection orifice area is the defined as a summation of the surface area of each fuel injection orifice of the set of fuel injection orifices 134. A ratio between the fuel injection office area and the flow area is greater than or equal to 0.005 and less than or equal to 0.06.

The ratios between the bluff area and the flow area, and between the fuel orifice injection area and the flow area are used to ensure that the fuel nozzle 106 operates as desired. For example, the ratio between the bluff area and the flow area is used to ensure that the mixture of fuel and air (Fm) that is fed to the combustion chamber 104 is stabilized along or otherwise anchored to a heat shield (e.g., the wall 102 of FIG. 4 or a body attached to the wall 102). The heat shield is used to insulate various portions of the combustion section 100 from the heat of the flame within the combustion chamber 104, which is especially important when using H2 fuel as H2 fuel has a higher burn temperature than conventional fuels. With too small of a ratio between the bluff area and the flow area, there is insufficient recirculation area (e.g., area for the mixture of fuel and air (Fm) to anchor to the heat shield) within the combustion chamber 104 resulting in instabilities, and therefore insufficient anchoring, of the flame within the combustion chamber 104. Conversely, with too high of a ratio between the bluff area and the flow area, too much of the flame is anchored to the heat shield, meaning that the heat shield is overly heated causing the effectiveness of the heat shield to diminish. Further, if there is too small of a ratio between the bluff area and the flow area, the flow of compressed air (Fc) and (Fa) being fed to the fuel nozzle 106 is restricted, causing a flow blockage from the compressor section (e.g., the compressor section 12 of FIG. 1) and to the combustion section 100.

Having too low of a ratio between the bluff area and the flow area results in an increased potential for flashback to occur. Put another way, if the velocity of the mixture of fuel and air (Fm) being fed to the combustion chamber 104 is too low, the mixture of fuel and air (Fm) is able to flashback (ignite into) the fuel nozzle 106 once the mixture of fuel and air (Fm) within the combustion chamber 104 is ignited. Having too high of a ratio between the bluff area and the flow area results in no practical way to feed enough fuel and air to the fuel nozzle 106 to achieve sufficient mass flow rate of the mixture of fuel and air (Fm) into the combustion chamber. Put another way, the higher the ratio, the more compressed air and fuel that needs to be fed to the fuel nozzle 106. If the ratio is too high, the requires volume of the primary flow of fuel (F1) and the flow of compressed air (Fc) to achieve the needed mass flow rate of the mixture of fuel and air (Fm) dictate by the ratio may be too high to achieve.

The mass flow rate and velocity of the fuel and air mixture (Fm) directly affects the capability of the primary flow of fuel (F1) to penetrate into the mixture of fuel and air (Fm). It will be appreciated that it is desired to have the primary flow of fuel (F1) farther (radially closer to the premixer centerline 112) to ensure that the primary flow of fuel (F1) is adequately mixed with the flow of compressed air (Fc). If the velocity of the mixture of fuel and air (Fm) is too high (e.g., the ratio between the bluff area and the flow area is too low), it will be more difficult for the primary flow of fuel (F1) to penetrate into the mixture of fuel and air (Fm). The ratio between the fuel orifice injection area and the flow area is used to determine a required flow rate through the set of fuel injection orifices 134 to ensure adequate penetration. As a non-limiting example, too small of a ratio between the fuel orifice injection area and the flow area (e.g., a smaller fuel injection orifice) will result in a choke of the primary flow of fuel (F1) such that not enough fuel within the primary flow of fuel (F1) is fed to the fuel nozzle 106. Too high of a ratio between the fuel orifice injection area and the flow area (e.g., a larger fuel injection orifice) will result in too much fuel at too low of a velocity being fed to the fuel nozzle 106. The ratios between the bluff area and the flow area, and between the fuel orifice injection area and the flow area have been placed within the aforementioned ranges to ensure that the primary flow of fuel (F1) is able to adequately penetrate the mixture of fuel and air (Fm), and that the mixture of fuel and air (Fm) is fed to the combustion chamber 104 at an adequate mass flow rate to avoid potential flashback.

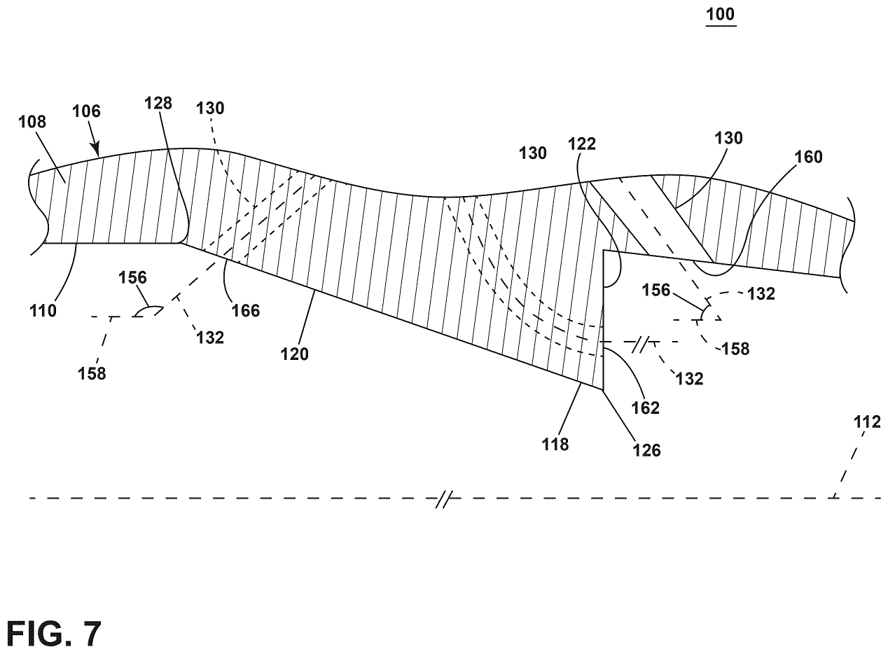

FIG. 7 is a schematic side cross-sectional view of the vortex generator 118 and premixer body 108 of FIG. 6 as viewed along a plane extending along the premixer centerline 112 and intersecting the apex 126. The set of fuel injection orifices 134 define terminations of a respective set of fuel injection channels 130, illustrated in phantom lines.

Each fuel injection channel of the set of fuel injection channels 130 extends through the premixer body 108, the vortex generator 118, or a combination thereof. The set of fuel injection channels 130 can be linear or non-linear. As a non-limiting example, the fuel injection channel of the set of fuel injection channels 130 terminating at the fuel injection orifice 134 at the first fuel orifice location 160 is linear. As a non-limiting example, the fuel injection channel of the set of fuel injection channels 130 terminating at the fuel injection orifice 134 at the second fuel orifice location 162 and the fourth fuel orifice location 166 are non-linear.

The set of fuel injection channels 130 are oriented to direct a flow of fluid exiting the set of fuel injection channels 130 (e.g., the primary flow of fuel (F1) of FIG. 3) in a desired direction. As a non-limiting example, at least one fuel injection channel of the set of fuel injection channels 130 can direct the flow of fluid exiting the at least one fuel injection channel in a axially forward fashion (e.g., the fuel injection channel terminating at the fuel injection orifice at the first fuel orifice location 160 or the second fuel orifice location 162) or in an axially rearward fashion (e.g., the fuel injection channel terminating at the fuel injection orifice at the fourth fuel orifice location 166). The direction that the flow of fluid is directed is quantified by the fuel channel angle 156. As a non-limiting example, a fuel channel angle 156 that is acute, but non-zero, can direct the flow of fluid axially downstream. As a non-limiting example, a fuel channel angle 156 that is obtuse, but not 90 degrees or 180 degrees, can direct the flow of fluid axially upstream. It is further contemplated that the fuel channel angle 156 can be zero degrees such that the flow of fluid exiting the fuel injection orifice 134 is parallel to the premixer centerline 112 and directs the flow of fluid either axially upstream or downstream.

Benefits of the present disclosure include a combustor suitable for use with a H2 fuel. As outlined previously, H2 fuels have a higher flame temperature, likelihood for flashback and likelihood for auto-ignition than traditional fuels (e.g., fuels not containing hydrogen). That is, H2 fuels have a wider flammable range and a faster burning velocity than traditional fuels such petroleum-based fuels, or petroleum and synthetic fuel blends. Additional structure to mitigate flashback and stop undesired auto-ignition is needed; problems not faced by combustors utilizing traditional fuels. The combustion section, as described herein, includes a fuel nozzle that effectively mixes the H2 fuel with the flow of compressed air, and further eliminates the negative areas associate with the use of the set of vortices. This, in turn, results in a mixture of fuel and air that is a homogenous mixture. The homogenous mixture, in turn, reduces the possibility of flashback and autoignition within the fuel nozzle. Further, the fuel nozzle is designed to ensure that the mixture is moving at an adequate velocity when fed to the combustion chamber to avoid flashback.

Ensuring the implementation of a homogenous mixture further curbs emissions (e.g., NOₓ emissions) from the combustion section. The combustion section as described herein is especially well adapted for use with a lean mixture of fuel and air, or otherwise well adapted for use with mixture of fuel and air having a relatively low amount of fuel. Using a lean mixture of fuel and air raises various issues. First, lean mixtures of fuel and air produce a flame, once ignited, that travels at a slower velocity than stoichiometric combinations of fuel and air. It is contemplated that the faster that a flame speed is (e.g., the faster that the mixture of fuel and air is), the harder it is for the mixture of fuel and air to overcome the possibility of flashback. Secondly, lean mixtures of fuel and air have tendencies to create pockets of increased volume of fuel (e.g., more stoichiometric pockets) within the mixture of fuel and air, thus increasing the risk of flashback occurring. The pockets created in the lean mixture of fuel and air, in turn, increase the risk of flashback. The combustion section, as described herein, however ensures that the mixture of fuel and air is of an adequate velocity (e.g., through the secondary flow of air, and the ratios described herein) to ensure that the lean mixture of fuel and air is moving fast enough to avoid flashback. The combustion section, as described herein, however further ensures that a homogenous mixture of fuel and air is created through, for example, use of the set of vortex generators. As such, the fuel nozzle as described herein is especially well adapted for use with lean mixtures of fuel and air. As the fuel nozzle effectively utilizes a lean mixture of fuel and air, the overall NOₓ emissions and the overall volume of fuel required are reduced.

Further the use of the set of vortex generators, as opposed to a conventional fuel nozzle that does not include the set of vortex generators, has been found to reduce NOₓ emissions from the combustion section. As discussed herein, the set of vortex generators create vortices within the combustion chamber that entrap or otherwise capture the flow of H2 fuel that is being output into the combustion chamber. The entrapment of the flow of H2 fuel, through the set of vortices, in turn helps with ensuring that the H2 fuel and the flow of compressed air are adequately mixed. Further, the use of the vortices help break up the flow of fuel, which allows for the length between the fuel nozzle outlet and a location where the primary flow of fuel is injected to be reduced. Put another way, the vortices mix the fuel within the compressed air fast enough to reduce the total space needed to create the homogenous mixture. Reducing the length between the fuel nozzle outlet and the location where the primary flow of fuel is injected, reduces the potential area for flashback or autoignition to occur. Put another way, the longer of a distance that the fuel and the compressed air need to mix, the larger the area is for autoignition or flashback to occur within the fuel nozzle. This is especially important for a combustion section utilizing H2 fuel as H2 fuel has a higher burn temperature, which can cause more damage than conventional fuels if flashback were to occur. Further, the more homogenous mixture of compressed air and gaseous fuel, in turn, reduces the overall NOₓ emissions of the combustion section once the mixture of compressed air and gaseous fuel is ignited.

Benefits associated with using hydrogen-containing fuel over traditional fuels include an eco-friendlier engine as the hydrogen-containing fuel, when combusted, generates less carbon pollutants than a combustor using traditional fuels. For example, a combustor including 100% hydrogen-containing fuel (e.g., the fuel is 100% H2) would have zero carbon pollutants. The combustor, as described herein, can be used in instances where 100% hydrogen-containing fuel is used.

To the extent not already described, the different features and structures of the various embodiments can be used in combination, or in substitution with each other as desired. All combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A fuel nozzle for a turbine engine comprising a compressor section, combustion section, and turbine section is serial flow arrangement, the fuel nozzle being provided within the combustion section and comprising a premixer body having a premixer centerline, the premixer body defining a primary flow path, a vortex generator extending into the primary flow path, an air injection orifice provided in the premixer body and located downstream of the vortex generator, and a fuel injection orifice provided along the premixer body and opening into the primary flow path, the fuel injection orifice being provided axially forward of the air injection orifice.

A fuel nozzle for a turbine engine comprising a compressor section, combustion section, and turbine section is serial flow arrangement, the fuel nozzle comprising a premixer body defining a primary flow path, a vortex generator extending into the primary flow path, and a fuel injection orifice provided along the premixer body and opening into the primary flow path, the fuel injection orifice being provided along the vortex generator.

The fuel nozzle of any preceding clause, wherein the air injection orifice emits a flow of compressed air into the primary flow path at a cross angle to the primary flow path.

The fuel nozzle of any preceding clause, further comprising a fuel injection channel exhausting into the primary flow path at the fuel injection orifice, the fuel injection channel having a fuel channel centerline intersecting the fuel injection orifice at a center point.

The fuel nozzle of any preceding clause, wherein the vortex generator extends between a farthest upstream portion and a farthest downstream portion a first axial distance, with respect to the premixer centerline, and the center point is provided a second axial distance from a farthest upstream portion of the vortex generator, with respect to the premixer centerline, the second axial distance being greater than 0% and less than or equal to 500% of the first axial distance.

The fuel nozzle of any preceding clause, wherein the premixer body includes a fuel nozzle outlet, the fuel nozzle outlet having a hydraulic diameter, and the center point is provided a first axial distance from the fuel nozzle outlet, the first axial distance being greater than 0 times and less than or equal to 200 times the hydraulic diameter.

The fuel nozzle of any preceding clause, further comprising a fuel manifold provided within the premixer body, with the fuel injection channel extending between the fuel manifold and the fuel injection orifice.

The fuel nozzle of any preceding clause, further comprising a centerbody extending through the primary flow path.

The fuel nozzle of any preceding clause, wherein the centerbody includes a central fuel channel exhausting into the primary flow path at a fuel jet.

The fuel nozzle of any preceding clause, wherein the fuel jet is provided downstream of the vortex generator.

The fuel nozzle of any preceding clause, wherein the vortex generator is included within a plurality of vortex generators circumferentially spaced along the premixer body, the fuel injection orifice is included within a plurality of fuel injection orifices circumferentially spaced along the premixer body, and each vortex generator of the plurality of vortex generators is circumferentially aligned with at least one fuel injection orifice of the plurality of fuel injection orifices.

The fuel nozzle of any preceding clause, wherein the fuel injection orifice is circumferentially aligned with the air injection orifice.

The fuel nozzle of any preceding clause, wherein the vortex generator is circumferentially oriented to direct a flow of compressed air flowing over the vortex generator in a circumferential direction such that the flow of compressed air includes a swirl number of greater than 0 and less than or equal to 1.

The fuel nozzle of any preceding clause, wherein the vortex generator is at least one of a counter-rotating vortex generator, a double-sided wedge, wheeler, wing, winglet, Kuethe, wishbone, hairpin, lobed, wave-type, or any combination thereof.

The fuel nozzle of any preceding clause, wherein the fuel injection orifice is configured to emit a primary flow of fuel into the primary flow path, the primary flow of fuel including a hydrogen fuel.

The fuel nozzle of any preceding clause, further comprising a centerbody extending through the primary flow path and having a central fuel channel, wherein the central fuel channel is configured to emit a secondary flow of fuel into the primary flow path, the primary flow of fuel including a fuel different from the fuel of the primary flow of fuel.

The fuel nozzle of any preceding clause, wherein the fuel injection orifice is at least one of provided along the vortex generator, axially between the vortex generator and the at least one air channel, or a combination thereof.

The fuel nozzle of any preceding clause, wherein the vortex generator comprises a leading edge and a trailing edge relative to the primary flow path.

The fuel nozzle of any preceding clause, wherein the fuel injection orifice is provided along the leading edge, provided along the trailing edge, or provided between the leading edge and the trailing edge.

The fuel nozzle of any preceding clause, wherein the fuel injection orifice is included within a plurality of fuel injection orifices provided along of the leading edge, the trailing edge, between the leading edge and the trailing edge, or a combination thereof.

What is claimed is:

1. A fuel nozzle for a turbine engine comprising a compressor section, combustion section, and turbine section is serial flow arrangement, the fuel nozzle being provided within the combustion section and comprising:
a premixer body having a premixer centerline, the premixer body defining a primary flow path;
a vortex generator extending into the primary flow path;
an air injection orifice provided in the premixer body and located downstream of the vortex generator; and
a fuel injection orifice provided along the premixer body and opening into the primary flow path, the fuel injection orifice being provided axially forward of the air injection orifice.

2. The fuel nozzle of claim 1, wherein the air injection orifice emits a flow of compressed air into the primary flow path at a cross angle to the primary flow path.

3. The fuel nozzle of claim 1, further comprising a fuel injection channel exhausting into the primary flow path at the fuel injection orifice, the fuel injection channel having a fuel channel centerline intersecting the fuel injection orifice at a center point.

4. The fuel nozzle of claim 3, wherein:
the vortex generator extends between a farthest upstream portion and a farthest downstream portion a first axial distance, with respect to the premixer centerline; and
the center point is provided a second axial distance from a farthest upstream portion of the vortex generator, with respect to the premixer centerline, the second axial distance being greater than 0% and less than or equal to 500% of the first axial distance.

5. The fuel nozzle of claim 3, wherein:
the premixer body includes a fuel nozzle outlet, the fuel nozzle outlet having a hydraulic diameter; and
the center point is provided a first axial distance from the fuel nozzle outlet, the first axial distance being greater than 0 times and less than or equal to 200 times the hydraulic diameter.

6. The fuel nozzle of claim 3, further comprising a fuel manifold provided within the premixer body, with the fuel injection channel extending between the fuel manifold and the fuel injection orifice.

7. The fuel nozzle of claim 1, further comprising a centerbody extending through the primary flow path.

8. The fuel nozzle of claim 7, wherein the centerbody includes a central fuel channel exhausting into the primary flow path at a fuel jet.

9. The fuel nozzle of claim 8, wherein the fuel jet is provided downstream of the vortex generator.

10. The fuel nozzle of claim 1, wherein:
the vortex generator is included within a plurality of vortex generators circumferentially spaced along the premixer body;
the fuel injection orifice is included within a plurality of fuel injection orifices circumferentially spaced along the premixer body; and
each vortex generator of the plurality of vortex generators is circumferentially aligned with at least one fuel injection orifice of the plurality of fuel injection orifices.

11. The fuel nozzle of claim 1, wherein the fuel injection orifice is circumferentially aligned with the air injection orifice.

12. The fuel nozzle of claim 1, wherein the vortex generator is circumferentially oriented to direct a flow of compressed air flowing over the vortex generator in a circumferential direction such that the flow of compressed air includes a swirl number of greater than 0 and less than or equal to 1.

13. The fuel nozzle of claim 1, wherein the vortex generator is at least one of a counter-rotating vortex generator, a double-sided wedge, wheeler, wing, winglet, Kuethe, wishbone, hairpin, lobed, or wave-type.

14. The fuel nozzle of claim 1, wherein the fuel injection orifice is configured to emit a primary flow of fuel into the primary flow path, the primary flow of fuel including a hydrogen fuel.

15. The fuel nozzle of claim 14, further comprising a centerbody extending through the primary flow path and having a central fuel channel, wherein the central fuel channel is configured to emit a secondary flow of fuel into the primary flow path, the primary flow of fuel including a fuel different from the fuel of the primary flow of fuel.

16. The fuel nozzle of claim 1, wherein the fuel injection orifice is at least one of provided along the vortex generator, axially between the vortex generator and the at least one air channel, or a combination thereof.

17. A fuel nozzle for a turbine engine comprising a compressor section, combustion section, and turbine section is serial flow arrangement, the fuel nozzle comprising:
a premixer body defining a primary flow path;
a vortex generator extending into the primary flow path; and
a fuel injection orifice provided along the premixer body and opening into the primary flow path, the fuel injection orifice being provided along the vortex generator.

18. The fuel nozzle of claim 16, wherein the vortex generator comprises a leading edge and a trailing edge relative to the primary flow path.

19. The fuel nozzle of claim 18, wherein the fuel injection orifice is provided along the leading edge, provided along the trailing edge, or provided between the leading edge and the trailing edge.

20. The fuel nozzle of claim 18, wherein the fuel injection orifice is included within a plurality of fuel injection orifices provided along of the leading edge, the trailing edge, between the leading edge and the trailing edge, or a combination thereof.
